(19) United States
(12) Patent Application Publication
(10) Pub. No.: US 2020/0168130 A1
(43) Pub. Date: May 28, 2020

(54) Hardwareless Mount For Product Display

(71) Applicant: Lloyd, Gerstner & Partners, Paramus, NJ (US)

(72) Inventors: Sungwoo KIM, Palisades Park, NJ (US); Robert GERSTNER, Ridgewood, NJ (US)

(73) Assignee: Lloyd, Gerstner & Partners

(21) Appl. No.: 16/694,783

(22) Filed: Nov. 25, 2019

Related U.S. Application Data
(60) Provisional application No. 62/771,437, filed on Nov. 26, 2018.

(51) Int. Cl. G09F 3/20; G09F 7/18

(52) U.S. Cl. CPC G09F 3/204; G09F 2007/183; G09F 7/18

(57) ABSTRACT

A snap mountable holder releasably attachable to a point of purchase display, the display having a beam proximate products for purchase, includes: a housing; a top lip at a top of the housing and configured to engage a top edge of the beam; and a bottom lip engaging a bottom edge of the beam. One of the top lip and the bottom lip has a non-slip grip engageable with the beam, and the other of the top lip and bottom lip has an enforced region and an unenforced region isolated from each other. The enforced region contains a snap-in feature, the housing being dimensioned in relation to a distance between the top edge and the bottom edge of the beam such that when the non-slip grip is engaged with the beam, the housing is rotatably engageable to the beam about the longitudinal axis of the beam by the snap-in feature.

### CROSS-REFERENCE TO RELATED APPLICATION

This application claims priority under 35 U.S.C. 119(e) from U.S. Provisional Patent Application No. 62/771,437, filed Nov. 26, 2018, the contents of which are incorporated by reference herein in their entirety.

### BACKGROUND OF THE INVENTION

### 1. Field of the Invention

The present invention is directed to a display for products and, more particularly, to product sample mounts for attaching product samples and/or product graphics to a point of purchase display without the need for tools or attachment hardware.

### 2. The Related Art

Displays for product samples are well known, particularly in connection with hardware, electrical components, plumbing couplings, and the like, as would typically be found in hardware retail stores. In such establishments, shelving is provided for containing inventory of the various products to allow consumers to select the desired products from the display. Proximate the location of the inventory for each product is a product information card containing artwork consisting of a picture of the product and containing information such as product part number, size, price, etc. The information card may be attached to existing shelving by adhesive or any other known manner. In some prior art embodiments, each information card is affixed to a mount which is then attached to shelving containing the inventory. The mounts may also include an actual sample of the component or product corresponding to the information card.

The existing displays in which component information cards are attached directly to shelving for the component have drawbacks in that the cards are cumbersome to change, replace or rearrange such as when inventory changes. For example, if adhesive or hook/loop fasteners are used to attach the cards directly to display shelving or to mounts affixed to the shelving, the cards have a tendency to be detached from the shelving as a result of consumer traffic and inadvertent contact. Moreover, the removal and replacement of the cards results in an unsightly point of purchase display due to the exposed adhesive or hook/loop fasteners left behind on the shelving.

If hardware is used to attach the cards, hardware is required to detach and then reattach the cards to the shelving. In addition, if mounts are used to attach the cards and/or component samples to the shelving by hardware, there is difficulty in repositioning the mounts, such as when components on the point-of-purchase display are rearranged. As an example, if hardware such as screws or other fasteners are used to attach the mounts to the shelving, the hardware needs to be removed or otherwise adjusted to reposition the mounts.

In certain configurations, a rail is affixed to the front of the shelving proximate product inventory, for attaching individual mounts to the shelving. The rail will include a J-channel for engaging with a slidable coupling on each mount such that hardware is not required for attachment or removal of the individual mounts to the rail. Such a system, however, also has drawbacks. In particular, an intermediate mount, i.e., a mount that is positioned in between two or more adjacent surrounding mounts, cannot be readily replaced without first sliding adjacent mounts off of an end of the rail, replacing the intermediate mount, and then re-installing the adjacent mounts, again, by slidable engagement. Such activity is time consuming and cumbersome.

### SUMMARY OF THE INVENTION

In view of the above deficiencies, it is an object of the present invention to provide an improved point of purchase display system wherein product information mounts are easily installable and removable from the display.

According to one aspect of the invention, this object may be achieved by a snap mountable holder or mount for releasable attachment to a point of purchase display, the display having a beam proximate products for purchase, the beam having a longitudinal axis, a top edge and a bottom edge and defining a distance therebetween. The holder includes: a housing having a front face, a rear face, a top and a bottom; a top lip arranged at the top of the housing and configured for positioning proximate the top edge of the beam; and a bottom lip arranged at the bottom of the housing and configured for positioning proximate the bottom edge of the beam. One of the top lip and the bottom lip has a non-slip grip engageable with one of the top edge and bottom edge of the beam, and the other of the top lip and bottom lip having an enforced region and an unenforced region isolated from each other. The enforced region contains a snap in feature oriented from a tapered front end toward a wide end proximate the rear face of the housing, with the housing being dimensioned in relation to the distance between the top edge and the bottom edge of the beam such that when the non-slip grip is engaged with the beam, the housing is rotatably engageable to the beam about the longitudinal axis of the beam by the snap-in feature engaging the beam, the enforced region bends away from the unenforced region until the wide end of the snap-in feature clears the beam. The front face has a receiving area configured to receive a member containing indicia related to a product for purchase positioned proximate the holder.

In another aspect, the receiving area includes first and second lips configured to receive the member containing the indicia, via a slidable or flex fit engagement of the member.

In another aspect, the holder further includes a product sample receiver configured to receive a product sample corresponding to the product for purchase.

In another aspect, the product sample receiver has a receiving area having mounting holes for receiving fasteners configured to removably mount the product sample to the holder for display.

In another aspect, the fasteners include screws.

In another aspect, the enforced region and the unenforced region are isolated from each other by cutouts formed in the other of the top lip and bottom lip.

In another aspect, the enforced region of the other of the top lip and bottom lip comprises at least one ramp, the at least one ramp and the cutouts cooperating to permit the other of the top lip and bottom lip to flex when the holder is attached to the rail.

In another aspect, the top lip and the bottom lip include strengthening ribs.

In another aspect, the non-slip grip includes one or more rubber bumpers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIGS. 1A-1E are perspective, exploded, rear perspective and detailed views, respectively, showing a first embodiment of a mount 10;

FIG. 2A-2E are perspective, exploded, rear perspective and detailed views, respectively, showing a second embodiment of a mount 12;

FIG. 3 is a front view showing mounts of both the first and second embodiments affixed to a rail;

FIGS. 4 and 5 are perspective and exploded views, respectively, showing both the first and second embodiments of the mounts affixed to, and detached from, a rail, respectively;

FIGS. 6A-6C show three different views of the mount 10 according to the first embodiment;

FIGS. 7A-7E show five different views of the mount 12 according to the second embodiment;

FIGS. 8A and 8B show perspective and exploded views of the mount 10 according to the first embodiment;

FIGS. 9A-9C show perspective and exploded views of mount 12 according to the second embodiment;

FIGS. 10A-10F are views illustrating the steps of attaching a mount to the rail; and

FIGS. 11A-11C are views illustrating the steps of detaching a mount from the rail.

### DETAILED DESCRIPTION OF THE PRESENTLY PREFERRED EMBODIMENTS

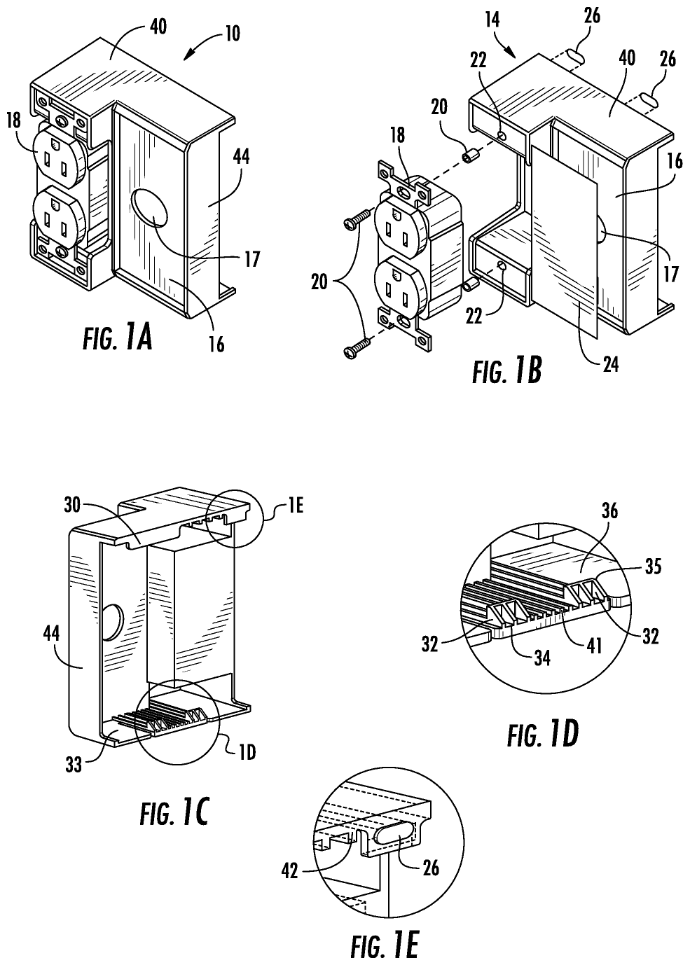

FIGS. 1A-1E are perspective, exploded, rear perspective and detailed views, respectively, showing a mount, i.e., holder 10, for displaying a product sample with associated graphics to consumers in a point-of-purchase display, according to a first embodiment of the present invention.

The mount 10 includes a sample holder portion 14 for holding a sample product 18 (such as, by way of non-limiting example, an electrical outlet accessory), which can be seen in FIGS. 1A and 1B. The mount 10 also includes a graphics holder portion 16 for holding a graphics card 24. The graphics card 24, shown, for example, in the exploded view of FIG. 1B, bears indicia of the product 18, such as a picture of the product 18, price information, specifications, etc.

The sample holder portion 14 is configured to provide an area to receive the sample product 18. As can be seen in the exploded/disassembled view of FIG. 1B, the receiving area includes mounting holes 22 for receiving fasteners 20, such as screws and associated washers, for mounting the sample product 18 to the mount in an intended manner. Once installed, the product sample is securely affixed to the mount 10, as can be seen in the assembled view of FIG. 1A.

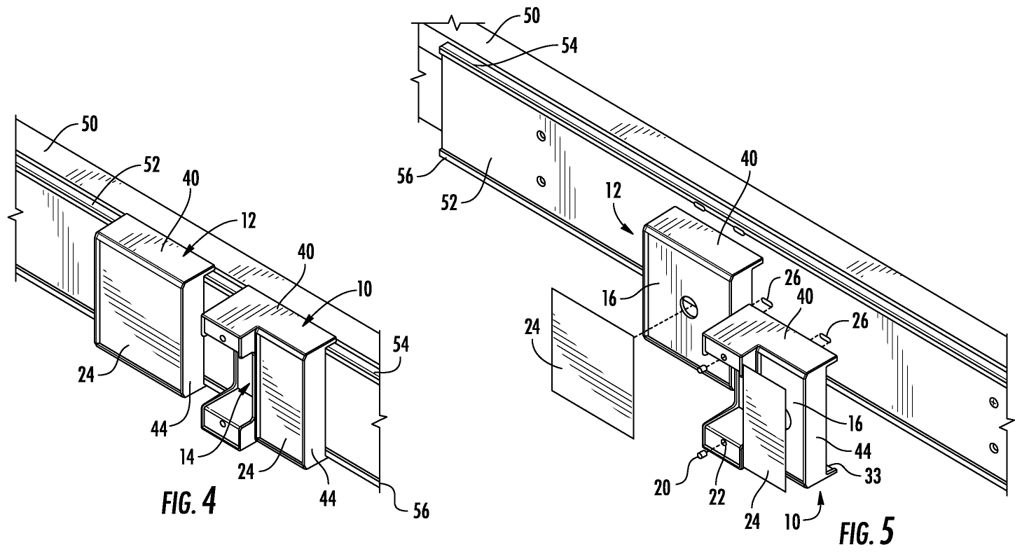

As can be seen most clearly in the views of FIGS. 1C and 1E, an upper surface 40 of the mount 10 includes a downwardly extending overhang portion or lip 30 having an inner surface oriented toward a front of the mount, namely toward the graphics portion 16. Grips 26, shown in the exploded view of FIG. 1B and the detail view of FIG. 1E, are preferably configured as one or more rubber bumpers and are affixed on the inner surface of the lip 30 to maintain the mount in a static manner as shown in detail of FIG. 1E. As discussed below, the grips 26 are configured to provide friction when engaging a rail 52 for mounting (see FIGS. 4 and 5 for example) to prevent or restrict the mount 10 from sliding along the rail 52.

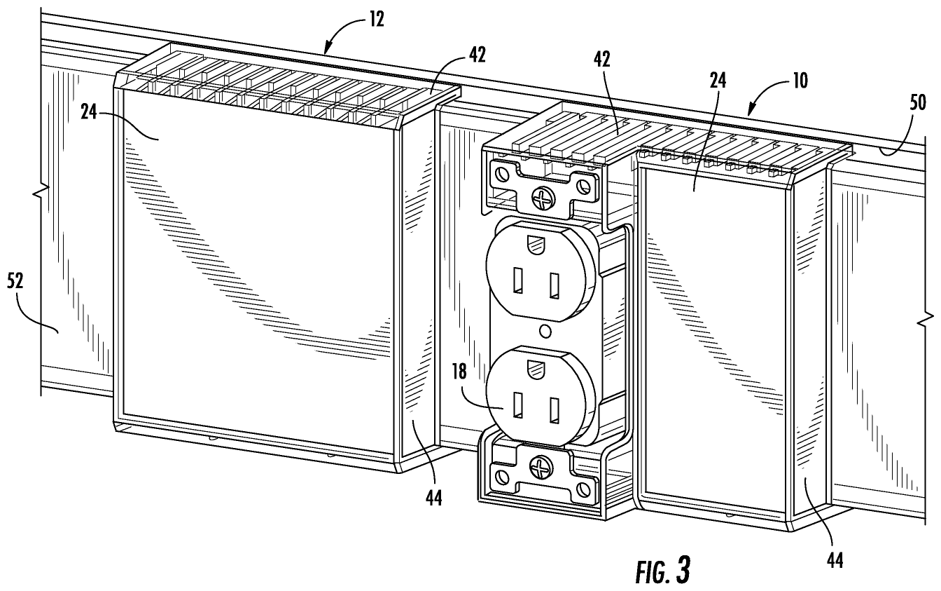

A bottom inner surface 33 of the mount 10, as most clearly seen in FIGS. 1C and 1D, supports one or more ramps 32, each having a narrow leading edge 34, an apex 35 and a following edge 36. A portion of surface 33 has strengthening ribs 41 (see FIG. 1D). The mount 10 also includes a top surface 40 having an inner surface with additional strengthening ribs 42, as shown in phantom in FIG. 1E, and best seen in FIGS. 3, 6A and 7A, discussed below in more detail. Lateral side surfaces 44 are formed along each side of the mount 10. The mount 10 is preferably made of plastic from injection molding processes. As a result, a cutout 17 is provided in the graphics holder portion 16 to release the mount from the mold during manufacturing.

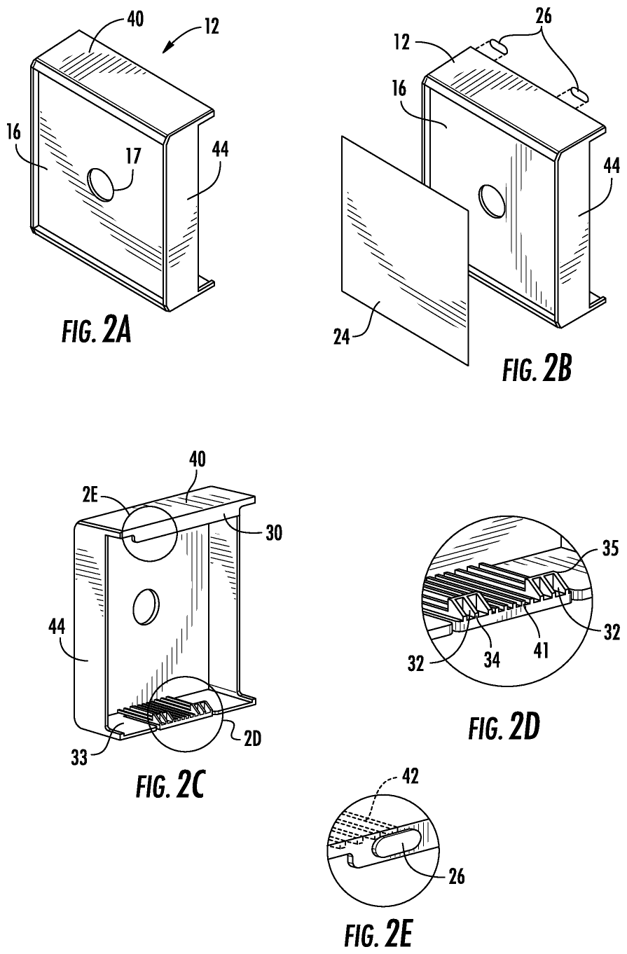

FIGS. 2A-2E are perspective, exploded, rear perspective and detailed views, respectively, showing the mount, i.e., holder 12, according to a second embodiment. In the second embodiment, the mount 12 has features similar to that of mount 10 except that there is no sample holder portion 14. Otherwise, the features are substantially the same, and identical reference numbers are used where applicable.

That is, the mount 12 includes a graphics holder portion 16 for holding a graphics card 24 bearing indicia of the product to be stored in a corresponding portion of the counter or shelf space, such as a picture of the product, price information, specifications, etc. As can be seen most clearly in the views of FIGS. 2C and 2E, an upper surface 40 of the mount 12 includes a downwardly extending overhang portion or lip 30 having an inner surface oriented toward a front of the mount, namely toward the graphics holder portion 16. Grips 26, shown in the exploded view of FIG. 2B and the detail view of FIG. 2E, are preferably configured as rubber bumpers, and are affixed on the inner surface of the lip 30 to maintain the mount 12 in a static manner as shown in detail of FIG. 2E. As discussed below, the grips 26 are configured provide friction when engaging a rail 52 for mounting (see FIGS. 4 and 5 for example) to prevent or restrict the mount 12 from sliding along the rail 52.

A bottom inner surface 33 of the mount 12, as most clearly seen in FIGS. 2C and 2D, supports one or more ramps 32 having a narrow leading edge 34, an apex 35 and a following edge 36. A portion of surface 33 has strengthening ribs 41 (see FIG. 1D). The mount 12 also includes a top surface 40 having an inner surface with additional strengthening ribs 42, which are visible in phantom in FIG. 2E, and which are best seen in FIGS. 3, 6A and 7A, discussed below in more detail. Lateral side surfaces 44 are formed along each side of the mount 12. The mount 12 is preferably made of plastic from injection molding processes. As a result, a cutout 17 is provided in the graphics holder portion 16 to release the mount from the mold during manufacturing.

FIGS. 3 and 4 are elevation and perspective views, respectively, showing mounts 10 and 12 connected to a mounting rail 52 affixed to a beam 50. The top surfaces 40 in FIG. 3 are shown as transparent to illustrate the underside strengthening ribs 42. In FIGS. 3 and 4, each of the mounts 10 and 12 are shown with a respective graphics card 24 installed.

FIGS. 3 and 4 each illustrate the mounts 10, 12 affixed to the mounting rail 52. As seen in FIG. 4, the rail 52, which is preferably formed of extruded aluminum, has an upper elongated edge 54 and a lower elongated edge 56, which lower elongated edge 56 is parallel to the upper edge 54.

FIG. 5 is an exploded view, i.e., a view showing the mounts 10, 12 removed from the rail 52. As can be seen in FIG. 5, each graphics card 24 is sized to fit the respective front face side of the corresponding graphics holder portion 16. The grips 26 are visible in the exploded/disassembled view of FIG. 5. FIG. 5 also illustrates the provision of the fasteners 20 and mounting holes 22, which, as discussed previously, are provided in the product receiving portion of mount 10.

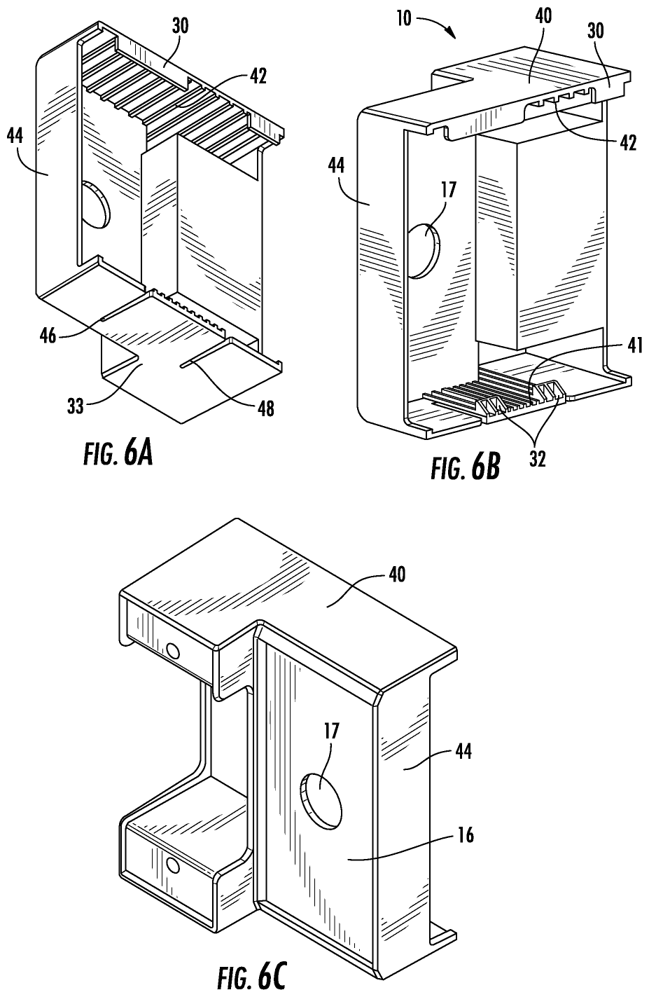

FIGS. 6A-6C are various views illustrating structures provided at inner portions of the upper surface 40 and the bottom surface 33 of the mount 10 according to the first embodiment. The ramps 32, best seen in FIG. 6B, are located at a middle, enforced, portion of the bottom surface 33 and are separated from unenforced sections on either side of the middle enforced portion by cutouts 46, 48 (see FIGS. 6A and 6B).

FIG. 6A is a perspective view from below, in which the cutouts 46, 48 are visible. The cutouts 46, 48 allow the middle portion of the bottom surface 33 containing the ramps 32 to flex downwardly when the mount is attached to the rail, as explained below. As a result, it is preferable to locate the bottom surface strengthening ribs 44 of the bottom surface 33 in the middle portion of the bottom surface 33.

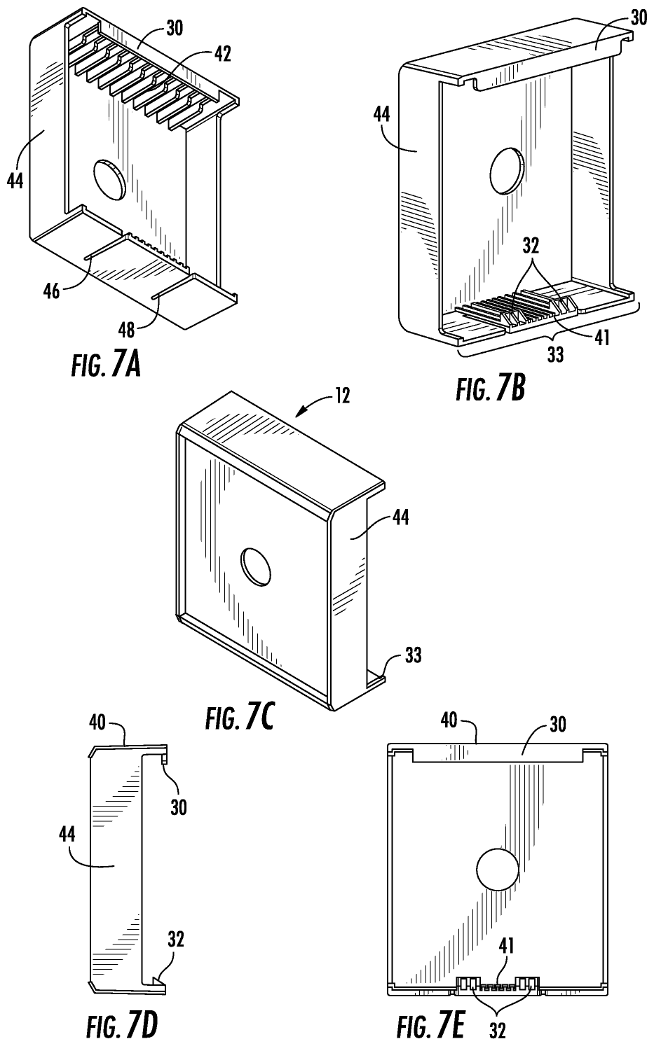

FIGS. 7A-7E are various views illustrating structures provided at inner portions of the upper surface 40 and the bottom surface 33 of the mount 12 according to the second embodiment. The ramps 32, best seen in FIG. 7B, are located at a middle portion of the bottom surface 33 and are separated from sections on either side of the middle portions by cutouts 46, 48 (see FIGS. 7A and 7B). FIG. 7A is a perspective view from below, in which the cutouts 46, 48 are visible. The cutouts 46, 48 allow the middle portion of the bottom surface 33 containing the ramps to flex downwardly when the mount is attached to the rail, as explained below. As a result, it is preferable to locate the bottom surface strengthening ribs 41 of the bottom surface 33 in the middle portion of the bottom surface 33.

FIGS. 7D and 7E are side and rear views, respectively, of the mount 12. The side view FIG. 7D illustrates the lip 30 having an angle approximately perpendicular to the front face of the mount 12. Together, the views of FIGS. 7D and 7E illustrate the positional orientation between the ramps 32 and the lip 30.

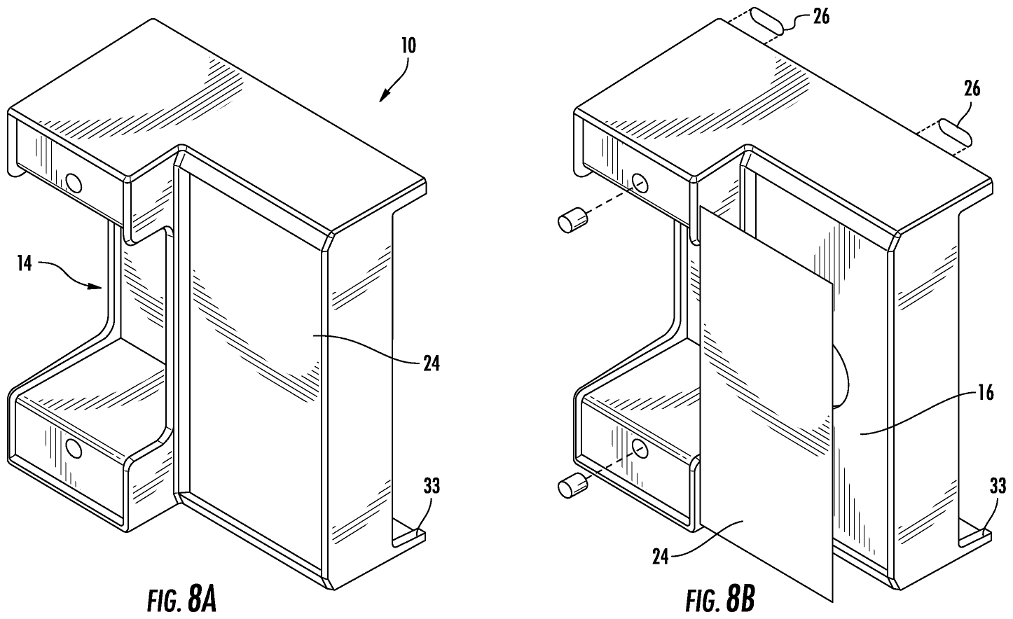

FIG. 8A is a perspective view of the mount 10 in accordance with the first embodiment with the graphic 24 positioned on the graphics holder portion 16. FIG. 8B is an exploded/unassembled view showing the graphic 24 separated from the mount 10. Attachment of the graphic 24 on the graphics holder portion 16 can be accomplished in any known manner such as by using adhesive, by providing a lip along a top edge and a lip along a bottom edge of portion 16 and then flexing a plastic graphic card so that a top edge and a bottom edge of the card are secured by the top and bottom lips, or by sliding the card into place at an edge of the lips.

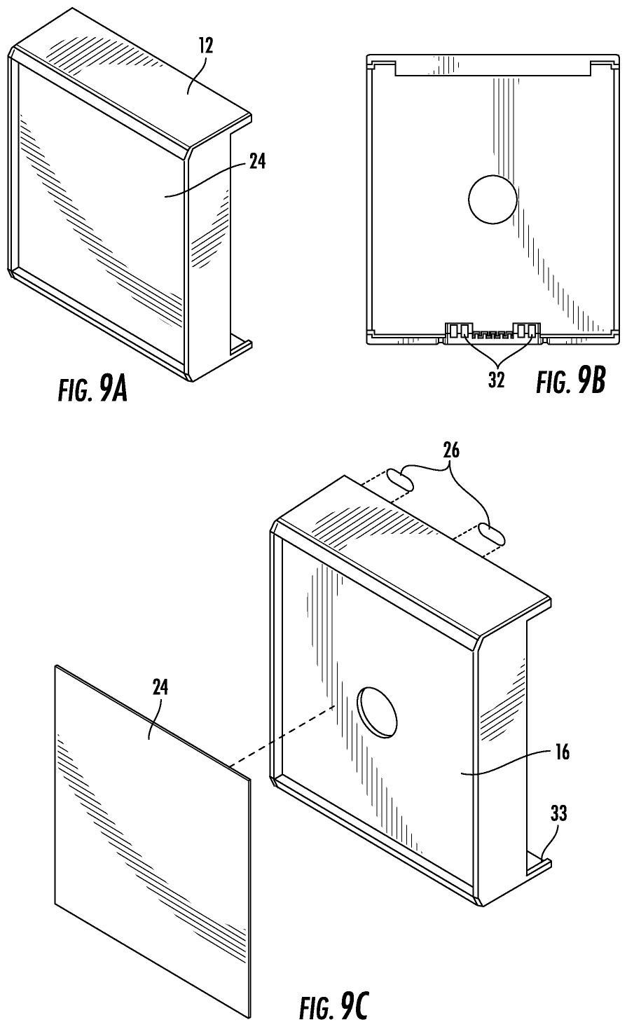

FIG. 9A is a perspective view of the mount 12 in accordance with the second embodiment with the graphic 24 positioned on the graphics holder portion 16. FIG. 9B is an exploded/unassembled view showing the graphic 24 separated from the mount 12. As in the case of the mount 10 of the first embodiment, attachment of the graphic 24 on the graphics holder portion 16 can be accomplished in any known manner such as using adhesive, by providing a lip along a top edge and a lip along a bottom edge of portion 16 and then flexing a flexible, for example plastic, graphic card so that a top edge and a bottom edge of the card are secured by the top and bottom lips, or by sliding the card into place at an edge of the lips.

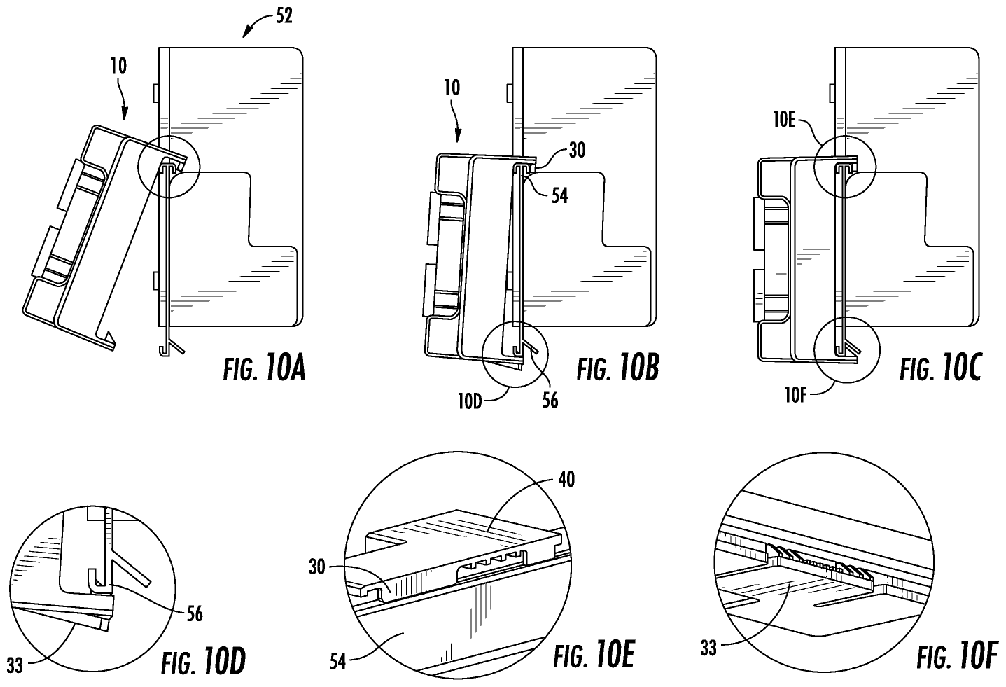

FIGS. 10A-10F are side and detail views illustrating the process for attachment of the mount to the rail. In the figures an example of a mount 10 and a rail 52 is illustrated. The following process would be exactly the same for the mount 12.

In an intended embodiment, the individual mounts may be provided in a “ready-to-attach” manner to a store clerk or other employee responsible for tending to a point of purchase display. Thus, the mounts will contain a graphics card 24 and, in the case of mount 10, a product sample already affixed thereto. Nevertheless, the cards or product samples can, likewise, be attached at the time the mounts are affixed the rail.

In either case, a clerk in a retail location in which the mounts are utilized, will then locate intended areas of a point-of-purchase display for attachment of the mounts proximate a product display area. In this described example, the rail 52 is already affixed to existing display shelving or the like.

In the process, the clerk will select a mount, and tilt it as shown in FIG. 10A to engage the upper overhang lip 30 with the upper elongated edge 54 of the rail 52. Thereafter, the clerk will rotate the mount by moving the bottom surface 33 toward the lower elongated edge 56 of the rail 52 (See FIGS. 10B and 10C) until the leading edges 34 of the ramps 32 are engaged by the rail 52.

As can be seen from the figures, engagement of the upper overhang lip 30 places the mount in position, with respect to the beam, for such rotation to be about an axis parallel to a longitudinal axis of the rail 52. The mount is dimensioned, with respect to the distance between the upper elongated edge 54 of the rail 52 and the lower elongated edge 56 of the rail 52, so that when the upper overhang lip 30 is engaged with the upper elongated edge 54 of the rail 52, the rotation for the engagement between the mount and the rail is about the axis parallel to the longitudinal axis of the rail 52

Continued pressing force will urge the middle portion of the bottom surface 33, i.e., the portion containing the ramps 32, downward until the apex 35 is reached, whereupon the middle portion will snap back into position such that the mount is held in place and the grips 26 are pressed against a rear surface of the rail 52. In this position, sideways motion of the mounts will be inhibited, for example by friction provided by the grips, thereby ensuring the mount stays in place proximate inventory of a product corresponding to the product sample and/or graphic held by the mount. In this manner, a display can be easily arranged by allowing a clerk to attach mounts to a point of purchase display without the need for any hardware or tooling. See areas of detail illustrated in FIGS. 10E and 10F.

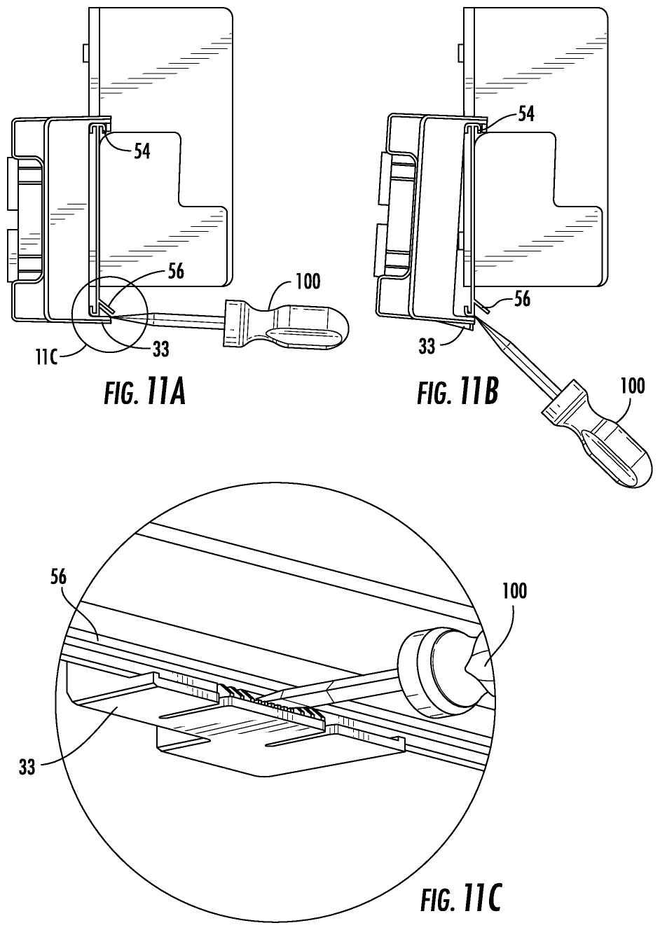

FIGS. 11A-11C illustrate a method of easily detaching the mount from the railing 52 using a flathead screwdriver 100 or similar tool by inserting the screwdriver head at the ramp apex between the lower rail edge 56 and applying a twisting motion. This motion will extend the bottom portion 33 of the mount in a downward direction, thereby releasing the ramp from the lower rail edge 56. Thereafter, the mount can be lifted off of the upper edge 54 of the rail 52. This allows for easy replacement of mounts on the display, such as when inventory is changed, etc.

While the engagement between the mount has been discussed with respect to upper and lower edges of the rail 52, it will be understood that the invention is not limited to this orientation. Thus, for example, the grips could be first engaged to a lower edge of a horizontally arranged rail 52, and the portion 33 could be snap fitted to the upper edge of the rail 52. Similarly, in the case of a vertically arranged/oriented rail 52, the grips could be engaged with either the right or left side of the rail 52, and the snap fit engagement can be made with the other side of the rail.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A snap mountable holder for releasable attachment to a point of purchase display, the display having a beam proximate products for purchase, the beam having a longitudinal axis, and having a top edge and a bottom edge, with a distance defined therebetween, the holder comprising:
a housing having a front face, a rear face, a top and a bottom;
a top lip arranged at the top of the housing and configured to engage the top edge of the beam; and
a bottom lip arranged at the bottom of the housing and configured to engage the bottom edge of the beam;
wherein one of the top lip and the bottom lip has a non-slip grip engageable with one of the top edge and bottom edge of the beam, and the other of the top lip and bottom lip has an enforced region and an unenforced region isolated from each other;
the enforced region containing a snap-in feature oriented from a tapered front end toward a wide end proximate the rear face of the housing, the housing being dimensioned in relation to the distance between the top edge and the bottom edge of the beam such that when the non-slip grip is engaged with the beam, the housing is rotatably engageable to the beam about the longitudinal axis of the beam by the snap-in feature engaging the beam, the enforced region bends away from the unenforced region until the wide end clears the beam; and
the front face having a receiving area configured to releasably receive a member containing indicia related to a product for purchase positioned proximate the holder,
wherein the rotatable engagement comprises rotating motion of the housing about an axis parallel to the longitudinal axis of the beam.

2. The holder according to claim 1, wherein the receiving area comprises first and second lips configured to receive the member containing the indicia, via a slidable or flex fit engagement of the member.

3. The holder according to claim 1, the holder further comprising a product sample receiver configured to receive a product sample corresponding to the product for purchase.

4. The holder according to claim 3, wherein the product sample receiver has a receiving area having mounting holes for receiving fasteners configured to removably mount the product sample to the holder for display.

5. The holder according to claim 4, wherein the fasteners comprise screws.

6. The holder according to claim 1, wherein the enforced region and the unenforced region are isolated from each other by cutouts formed in the other of the top lip and bottom lip.

7. The holder according to claim 6, wherein the enforced region of the other of the top lip and bottom lip comprises at least one ramp, the at least one ramp and the cutouts cooperating to permit the other of the top lip and bottom lip to flex when the holder is attached to the rail.

8. The holder according to claim 1, wherein of the top lip and the bottom lip include strengthening ribs.

9. The holder according to claim 1, wherein the non-slip grip comprises one or more rubber bumpers.
